(19) United States
(12) Patent Application Publication
(10) Pub. No.: US 2026/0054810 A1
(43) Pub. Date: Feb. 26, 2026

(54) Clutch System for a Trolling Motor and Unexpected Trim Event Sensor

(71) Applicants: Ryan Joseph Geissler, Mankato, MN (US); Brent Leo Konradi, Kasota, MN (US); Michael John Borglum, Le Sueur, MN (US)

(72) Inventors: Ryan Joseph Geissler, Mankato, MN (US); Brent Leo Konradi, Kasota, MN (US); Michael John Borglum, Le Sueur, MN (US)

(73) Assignee: Johnson Outdoors Inc., Racine, WI (US)

(21) Appl. No.: 18/810,028

(22) Filed: Aug. 20, 2024

(51) Int. Cl. B63H 20/00; B63B 49/00; B63B 79/10; B63B 79/30; B63B 79/40; B63H 20/10; B63H 20/12; B63H 20/14; F16D 41/067

(52) U.S. Cl. CPC B63H 20/007; B63B 49/00; B63B 79/10; B63B 79/30; B63B 79/40; B63H 20/10; B63H 20/12; B63H 20/14; F16D 41/067

(57) ABSTRACT

A trolling motor configured to avoid damage due to vertical impact forces is provided. The trolling motor is also configured to sense such impact forces. The trolling motor includes an electronic trim motor for electrically controlling the trim position. A clutch is interposed between the trim motor and the propulsion unit to disengage the trim motor from the propulsion unit upon the propulsion unit being exposed to an impact force greater than a predetermined amount. A sensor may be present to sense unexpected trim events.

### FIELD OF THE INVENTION

This invention generally relates to trolling motors and particularly trolling motors that are trimmable to adjust a depth of the propulsion unit relative to a surface of a body of water when in use.

### BACKGROUND OF THE INVENTION

Trolling motors are used to steer and/or provide propulsion to watercraft. One type of trolling motor includes electronic steering as well electronic trimming of the trolling motor to make it easier for a user to control the operation of the trolling motor. More particularly, the user would not be required to manually steer the thrust unit of the trolling motor or manually trim the trolling motor by manually adjusting the depth of the thrust unit by manually adjusting the vertical position of the thrust unit when in a deployed state.

Typically, the trolling motor includes a base that mounts the trolling motor to the watercraft. A steering motor rotates the thrust unit relative to the base and a trim motor adjusts the position of the thrust unit along a thrust axis to adjust the depth of the thrust unit within the water when the thrust unit is in the deployed state.

To properly control the trim position, the motor is operably coupled to the thrust unit to drive it in both axial directions (e.g. deeper and shallower) along the trim axis. Unfortunately, when a watercraft is exposed to waves, the boat will move vertically up and down with in the water and relative to the bottom of the body of water and any objects within the water.

Unfortunately, this up and down movement of the boat also carries the trolling motor and its thrust unit up and down along with it. This up and down motion can be very significant. This can cause the trolling motor to be lifted above and then slammed down onto the bottom of the body of water or any obstructions within the body of water. This motion can generate very large external loads on the propulsion unit including loads parallel to the trim axis which generates forces that attempt to back drive the trim motor. However, the trim motor and rest of the trim assembly is/are configured to fix the trim position of the propulsion unit so that it stays at the user desired depth relative to the surface of the water.

Unfortunately, with the propulsion unit being fixed at the desired trim position, these loads can damage the trim motor, the thrust unit, or other components of the trim assembly used to adjust the trim position of the motor.

### BRIEF SUMMARY OF THE INVENTION

Embodiments of the application provide new and improved clutch systems for trolling motors and particularly clutch systems to protect components of a trim system for adjusting the trim position of a propulsion unit of the trolling motor.

In one example, a trolling motor is provided that includes a base, a propulsion unit, a trim motor, and a trim clutch. The base is configured to be attached to a boat. The propulsion unit is configured to generate thrust along a thrust axis of the propulsion unit when in use within a body of water. The propulsion unit is moveable relative to the base along a trim axis to adjust a trim position of the propulsion unit relative to a surface of the body of water when in use. The trim motor is operably attached to the propulsion unit and is configured to drive the propulsion unit along the trim axis to adjust the trim position of the propulsion unit. The trim clutch is interposed between the trim motor and the propulsion unit. The trim clutch has an engaged configuration in which operation of the trim motor drives the propulsion unit along the trim axis and a disengaged configuration in which the propulsion unit is moveable relative to the base along the trim axis without back driving the trim motor. The trim clutch is configured to transition from the engaged configuration to the disengaged configuration when at least a predetermined external load parallel to the trim axis is applied to the propulsion unit.

In one example, the trolling motor includes a steering motor operably attached to the propulsion unit to rotate the propulsion unit about the trim axis to adjust an angular orientation of the thrust axis relative to the base. The trim clutch is not associated with steering the propulsion unit.

In one example, the trim clutch is part of a drive train interposed between the trim motor and the propulsion unit. The drive train includes a first trim gear operably coupled to the propulsion unit. The first trim gear rotates about a trim clutch axis. A second trim gear is operably driven by the trim motor for rotation about the trim clutch axis. The trim clutch is interposed between the first and second trim gears. The trim clutch operably rotationally couples the first trim gear to the second trim gear when in the engaged configuration and rotationally decouples the first trim gear from the second trim gear when in the disengaged configuration. Interposed may include situations where components of the clutch are formed with the trim gears.

In one example, the trim clutch includes a first carrier rotationally fixed to one of the first or second first trim gears. The first carrier has a first pocket. The trim clutch includes a second carrier rotationally fixed to the other one of the first or second trim gears. The second carrier has a second pocket. The trim clutch includes a clutch engagement member. The clutch engagement member is located in the first and second pockets rotationally fixing the first carrier to the second carrier when the trim clutch is in the engaged configuration. The clutch engagement member is removed from the first pocket when the trim clutch is in the disengaged configuration such that the first carrier is not rotationally fixed to the second carrier.

In one example, the first pocket, second pocket and clutch engagement member are configured to transition the clutch engagement member out of the first pocket due to application of the predetermined external load parallel to the trim axis to the propulsion unit.

In one example, the clutch engagement member is a clutch ball. The clutch ball extends into the first pocket a depth less than a radius of the clutch ball such that any force applied between the first carrier and the clutch ball is offset from the great circle of the clutch ball. A biasing member acts to bias the clutch ball into the first pocket to maintain the clutch in the engaged configuration until the predetermined external force is applied to the propulsion unit.

In one example, the load applied by the biasing member is adjustable.

In one example, the second pocket of the second carrier engages the clutch ball at a great circle of the clutch ball. The clutch ball is axially slidable parallel to the clutch trim clutch axis within the second pocket when transitioning between the engaged and disengaged configurations while the second carrier remains engaged with the great circle of the clutch ball.

In one example, when the predetermined external force is applied to the propulsion unit, the clutch ball moves axially parallel to the trim clutch axis and angularly about the trim clutch axis to allow the first carrier to move angularly relative to the second carrier.

In one example, the trim clutch includes a drive ball retainer having a plurality of drive ball detents angularly spaced about a trim clutch axis. The trim clutch includes a drive spider having a drive ball carrier recess. The drive spider is angularly moveable relative to the drive ball retainer when the trim clutch is in the disengaged configuration. The trim clutch includes at least one clutch engagement member in the form of a clutch ball receivable in the drive ball detents. When in the engaged configuration, the clutch ball rotationally fixes the drive ball retainer to the drive spider when the clutch ball is located within a first one of the drive ball detents and the drive ball carrier recess. When in the disengaged configuration, the clutch ball may move about the clutch axis angularly from a first one of the drive ball detents to an angularly adjacent second one of the drive ball detents allowing angular movement of the drive ball retainer relative to the drive spider without rotationally back driving the trim motor.

In one example, the clutch ball remains in the drive ball carrier recess of the drive spider as the clutch ball transitions from the first one of the drive ball detents to the second one of the drive ball detents.

In one example, the drive ball detents are configured to require the clutch ball to move radially relative to the trim clutch axis and parallel to the trim clutch axis to disengage and remove the clutch ball from the drive ball detent to transition the trim clutch from the engaged configuration to the disengaged configuration. The drive ball carrier recess of the drive spider is configured to allow the clutch ball to move parallel to the trim clutch axis and radially relative to the trim clutch axis while remaining within the drive ball carrier recess as the trim clutch transitions from the engaged configuration to the disengaged configuration.

In one example, a biasing member biases the clutch ball toward engagement with an angularly aligned one of the plurality of drive ball detents until the predetermined external load is applied to the propulsion unit such that sufficient torque is generated between the drive ball carrier and the drive spider to drive the clutch ball out of the angularly aligned one of the plurality of drive ball detents.

In one example, the drive spider has a plurality of angularly spaced apart drive ball recesses and the at least one clutch engagement member includes a plurality of drive balls, each drive ball recess having a drive ball therein.

In one example, there is no limit to the amount of angular displacement about the clutch trim axis that the drive ball retainer may travel relative to the drive spider. The components may make unlimited full rotations about the axis relative to one another.

In one example, the drive ball retainer includes an annular sidewall extending axially parallel to the clutch axis from a first face of an end wall. Each drive ball carrier recess has a portion formed in a radially inner surface of the annular sidewall and a portion formed in the first face of the end wall.

In one example, the drive ball retainer is formed as a one piece construction with a gear of the drive train.

In one example, the clutch ball travels along the first face of the end wall as the clutch ball transitions between adjacent drive ball retainer recesses when the drive spider moves angularly relative to the drive ball retainer when the trim clutch is in the disengaged configuration.

In one example, the trim axis is generally orthogonal to the thrust axis.

In one example, the base and propulsion unit have a deployed configuration in which the trim axis is generally vertical.

In one example, the trim clutch axis is perpendicular to the trim axis when the trim motor drives the propulsion unit along the trim axis.

In one example, the trim clutch includes a first carrier rotationally coupled to and driven by the trim motor, the first carrier having a first pocket. The trim clutch includes a second carrier rotationally coupled to the propulsion unit to drive the propulsion unit along the trim axis, the second carrier having a second pocket. The trim clutch includes a clutch engagement member. The clutch engagement member is located in the first and second pockets rotationally fixing the first carrier to the second carrier when the trim clutch is in the engaged configuration. The clutch engagement member is removed from at least one of the first or second pockets when the trim clutch is in the disengaged configuration such that the first carrier is not rotationally fixed to the second carrier and the trim motor is decoupled from the propulsion unit.

In one example, the clutch engagement member is a drive ball, one of the first and second carriers is a drive ball retainer, and one of the first and second carriers is a drive spider. The drive ball is removed from the pocket of the drive ball retainer in the disengaged configuration.

In one example, the drive spider has a plurality of angularly spaced apart legs extending from a central region. Gaps between the legs form pockets.

In one example, the drive ball, drive ball retainer, and drive spider are configured such that torque generated by the predetermined external force causes the drive ball to be driven out of the first pocket but that the drive ball remains within the second pocket as the drive ball retainer rotates relative to the drive spider about the trim clutch axis.

In one example, the trim clutch includes a first carrier rotationally coupled to and driven by the trim motor. The first carrier has a first pocket. The trim clutch includes a second carrier rotationally coupled to the propulsion unit to drive the propulsion unit along the trim axis. The second carrier has a second pocket. The trim clutch includes a clutch engagement member. The clutch engagement member is located in the first and second pockets rotationally fixing the first carrier to the second carrier when the trim clutch is in the engaged configuration. The clutch engagement member is removed from at least one of the first or second pockets when the trim clutch is in the disengaged configuration such that the first carrier is not rotationally fixed to the second carrier and the trim motor is decoupled from the propulsion unit.

In one example, the system includes a trim sensor assembly having a controller configured to receive trim position information from a propulsion unit trim sensor. The propulsion unit trim sensor senses the position of the propulsion unit along the trim axis. The controller is configured to determine that an unexpected trim event has occurred when a change in the position of the propulsion unit is sensed by the propulsion unit trim sensor without a corresponding trim input.

The trim input could be automatically generated by an external system or a user input device. For example, automatic trim could occur based on a change in depth of the water while manual input could be used by pressing a button on a remote, a phone app, a fish finder, the trolling motor, etc.

In one example, the sensor assembly includes storage for storing when an unexpected trim event occurs.

In one example, the sensor assembly is configured to store, in storage, the amount of change in trim associated with a sensed unexpected trim event.

In one example, the controller is configured to induce an error signal upon determining that an unexpected trim event has occurred.

In one example, the error signal may be used for or include an audible alarm, a visual alarm, a notification on a remote for controlling the trolling motor, generating a notification on a fish finder, or a notification on a phone.

In one example, the trim sensor is configured to generate an unexpected trim event error signal to the user to query the user if there was an unexpected trim event, the trim sensor assembly is configured to receive an input from the user to determine whether the sensed unexpected trim event was an undesired unexpected trim event.

In one example, the sensor assembly is configured to output an error signal upon sensing an unexpected trim event.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective illustration of a trolling motor;

FIG. 2 is a simplified partial illustration of a trolling motor mounted to a watercraft within a body of water;

FIG. 3 is a partial illustration of the trolling motor of FIG. 1 with a cover removed exposing the trim motor and associated components;

FIG. 4 is a cross-sectional illustration of the trim system for the trolling motor of FIG. 1;

FIG. 5 is a cross-sectional illustration of the trim system for the trolling motor of FIG. 1;

FIG. 6 is a cross-sectional illustration of the trim system for the trolling motor of FIG. 1;

FIG. 7 is an exploded illustration of a trim clutch for the trolling motor of FIG. 1;

FIG. 8 is a side view of the trim clutch in an assembled state in FIG. 7 showing the clutch in an engaged configuration;

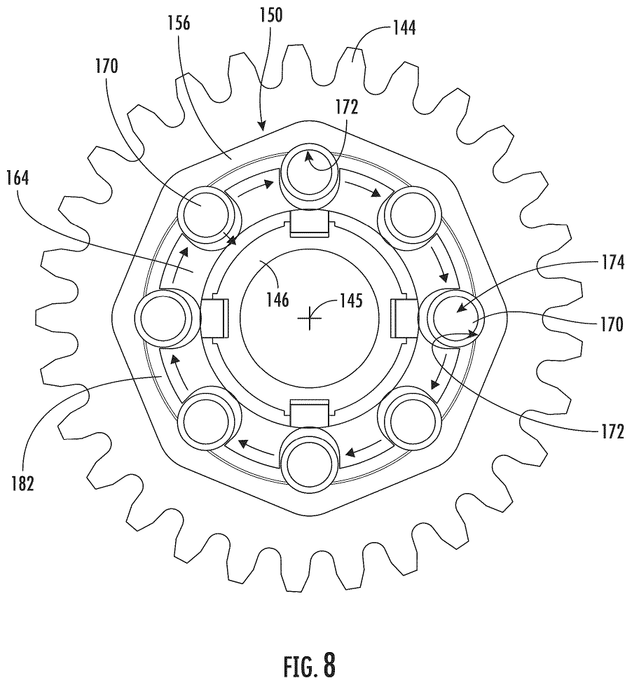

FIG. 9 is a cross-sectional illustration of the trim clutch showing the clutch ball transitioning from an engaged configuration to a disengaged configuration;

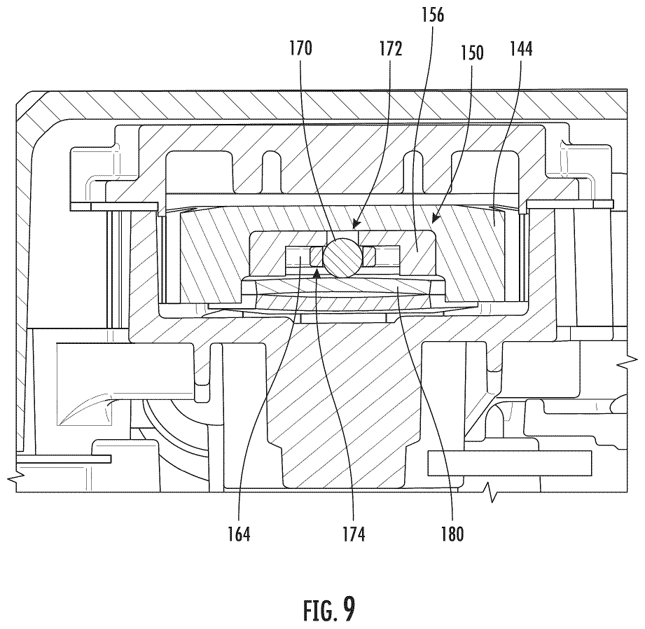

FIG. 10 is a partial illustration of the trolling motor of FIG. 1 having a housing component and the trim motor removed showing a trim sensor gear train;

FIG. 11 is a schematic illustration of the operation of the trim sensor system of the trolling motor of FIG. 1; and

FIG. 12 is a perspective illustration of an alternative trim gear that has a drive ball carrier incorporated therein as a single one piece component.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

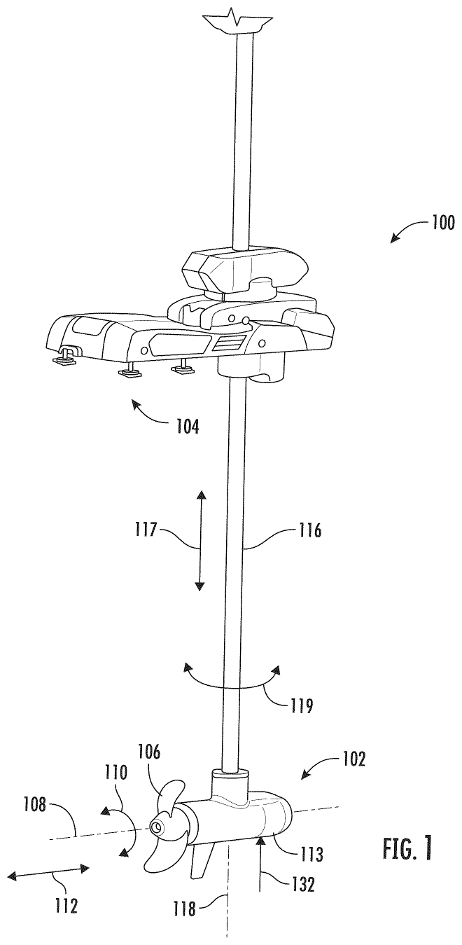

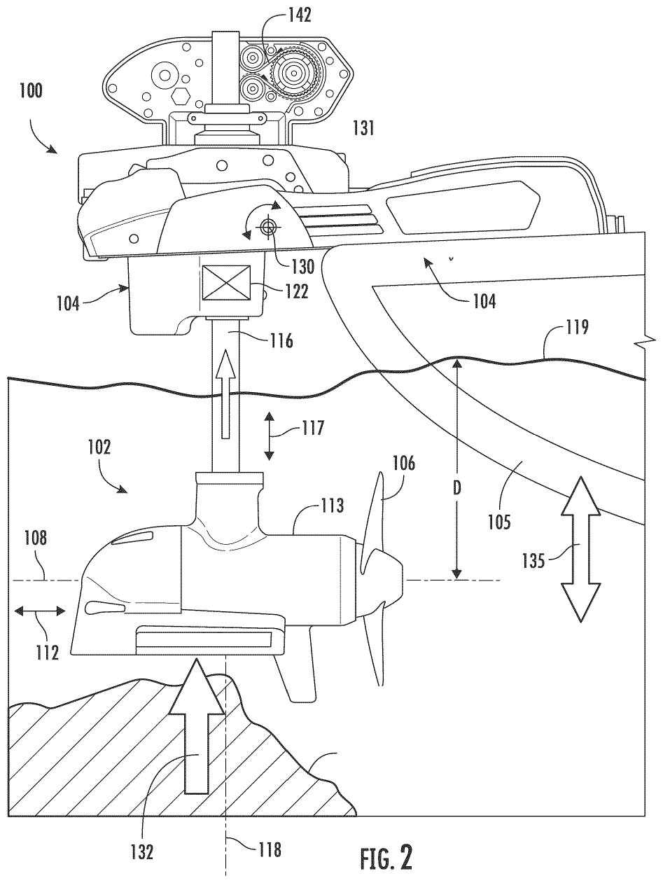

FIG. 1 is a trolling motor 100 for generating propulsion to move and/or steer a watercraft 105 (see e.g. FIG. 2). The trolling motor 100 generally includes a propulsion unit 102 to generate the propulsion and a base 104 for operably attaching the trolling motor 100 to the watercraft 105. Here the base 104 may include bolts or screws for attaching to the watercraft 105. However other options for securing to the watercraft are contemplated.

The propulsion unit 102, in this example, includes a propeller 106 that rotates (illustrated by arrow 110—see e.g. FIG. 1) to generate thrust (illustrated by arrow 112—see e.g. FIG. 1 or 2) about a thrust axis 108 depending on the direction of rotation. While not shown, a motor located within housing 113 operably drives propeller 106. The motor may be electric, gas powered, or any other means for driving the propeller. Also, other mechanisms for generating thrust within water other than a rotating propeller may be incorporated into trolling motor 100.

In this example, the propulsion unit 102 is trimmable relative to base 104. This allows the position of the propulsion unit 102 to be adjusted relative to base 104 along a trim axis 118, as illustrated by arrow 117. This allows the depth D of the propeller 106 of the propulsion unit 102 to be adjusted relative to the surface 119 of the water in which the trolling motor 100 is being used. In this example, a shaft 116 extending along trim axis 118 is coupled to housing 113. The shaft 116 is operably movable parallel to axis 118 relative to base 104 to adjust the trim position of the propulsion unit 102.

In use, the trim axis 118 is generally orthogonal to the surface 119 of the body of water. In use, this is typically going to be parallel to gravity.

In addition to being trimmable, i.e. axially positional along trim axis 118, the propulsion unit 102 is steerable. In particular, the propulsion unit is rotatable angularly (illustrated by arrow 119 in FIG. 1) about trim axis 118 allowing the orientation of the thrust axis 108 to be changed so as to change the direction of the thrust generated by the propulsion unit 102. A steering motor 122, illustrated schematically in FIG. 2, is operably coupled to the propulsion unit 102 and particularly shaft 116 so as to allow for a user to steer the propulsion unit 102 by way of user inputs.

The user inputs may be made by way of a foot pedal, remote control, operably connected fish finder, an app on a phone, or other means for controlling steering motor 122. These inputs may be sent to the motor 122 wirelessly or by wire.

In addition to being trimmable and steerable, the propulsion unit 102 may be stowable and deployable. This allows the user to position the propulsion unit 102 above the watercraft 105 proximate the deck of the watercraft 105. In this example, the propulsion unit 102 pivots about deployment axis 130 as illustrated by arrow 132 to transition between stowed (not shown) and deployed (shown in FIG. 2) orientations relative to the base 104. Stowing and deploying may be done using a motor or could be done by user manipulation depending on the implementation.

Typically, when stowed, the trim axis 118 is generally parallel to the surface 119 of the water and when deployed the trim axis 118 is generally orthogonal to the surface 119 (e.g. plus or minus 15 degrees). However, other orientations are contemplated.

As noted above, the propulsion unit 102 may be exposed to significant external impact forces, such as force 132 illustrated in FIG. 2, when the propulsion unit 102 hits the bottom 134 of the body of water such as when the watercraft moves up and down (as represented by arrow 135) relative to the bottom 134 of the body of water due to waves, wind or other things acting on the water and/or watercraft 105. However, as noted, the trolling motor 100 is generally configured to fix the trim position of the propulsion unit 102 relative to the watercraft 105 so that the propulsion unit 102 remains at the desired depth within the water column. Again, these forces 132 can thus result in damage to the trolling motor 100, the propulsion unit 102, the base 104, the location where the base 104 is attached to the watercraft 105, or the components of the trolling motor 100 used to adjust the trim position of the propulsion unit 102.

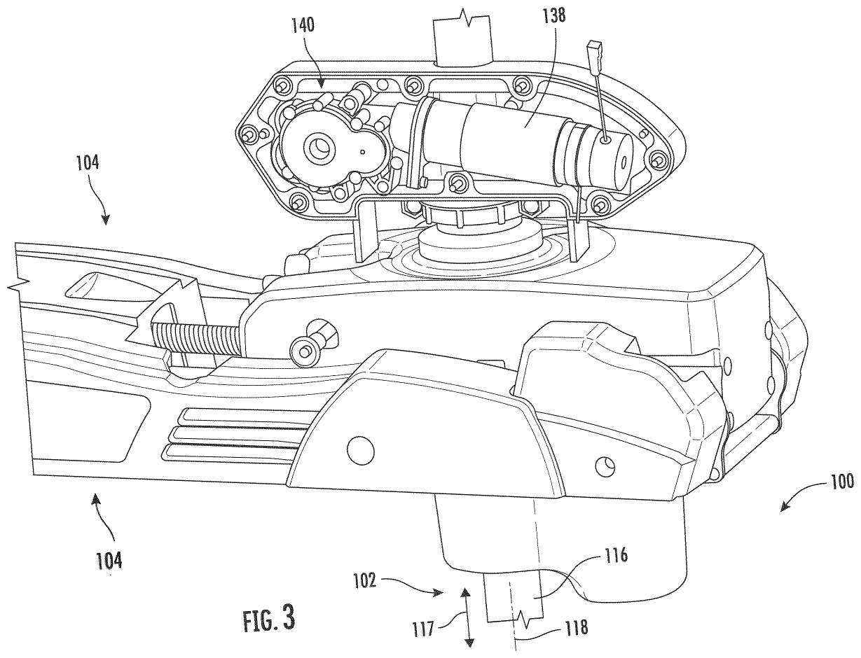

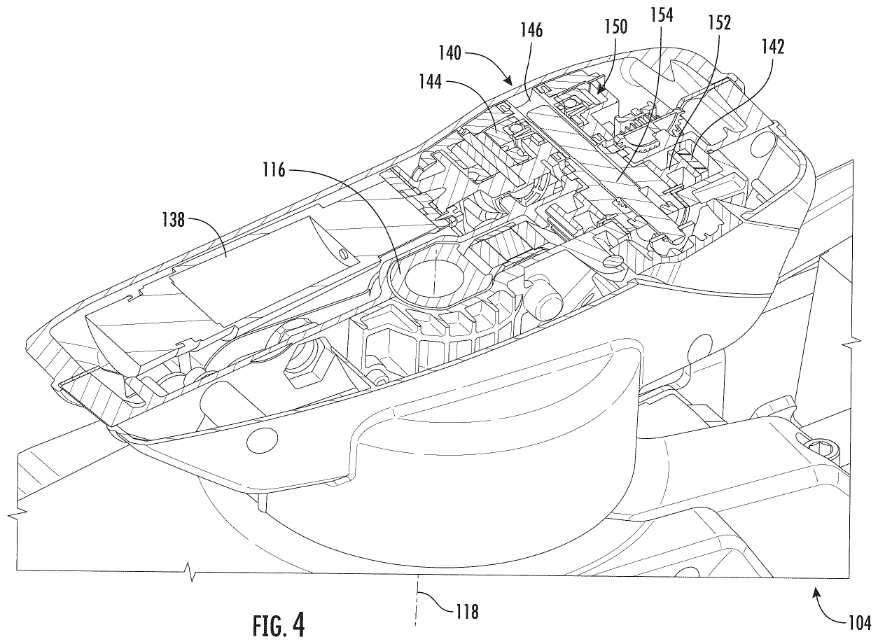

With reference to FIGS. 2-4, in this example, a trim motor 138 is operably attached to the propulsion unit 102 to drive the propulsion unit 102 along the trim axis 118. More particularly, depending on the direction of rotation of the motor, the propulsion unit will either be moved in a first direction to lower the propulsion unit 102 or in a second opposite direction to raise the propulsion unit 102.

A gear train 140 operably couples the trim motor 138 to a lift belt 142 that is operably secured to the propulsion unit 102 and in some particular embodiments to opposite ends of shaft 116. The gear train 140 and lift belt 142 convert the rotary motion of the trim motor 138 into linear motion of the propulsion unit 102, and particularly shaft 116, along trim axis 118.

In this example, a first trim gear 144 is operably coupled to a clutch drive hub 146 by way of a trim clutch 150. The drive hub 146 is operably coupled to a drive pully 152 by way of a trim shaft 154. The trim shaft 154 and drive hub 146, in this example, have a splined engagement such that torques are transferred therebetween.

The drive pully 152, which may be referred to as a trim gear, meshes with the lift belt 142 such that during normal operation, the trim motor 138 can operably drive the lift belt 142 to adjust the trim position of the propulsion unit 102. The drive pully 152 can raise or lower the propulsion unit 102 depending on the direction of operation of the trim motor 138.

The first trim gear 144 is operably connected to the output of the trim motor 138 and rotates about axis 145. The trim clutch 150 operably rotationally couples the first trim gear 144 to the drive hub 146. Rotation of the drive hub 146 about axis 145 drives trim shaft 154 about axis 145 which in turn rotates drive pulley 152 about axis 145 to drive the lift belt 142. Again, the direction of rotation of the trim motor 138 determines whether the lift belt 142 raises or lowers the propulsion unit 102 along trim axis 118.which is operably connected to the trim shaft 154.

Unfortunately, the external impact forces 132 applied to the propulsion unit 102 are translated through the lift belt 142 into rotational back driving torque. As noted, this can be detrimental to the components of the trim assembly.

Trim clutch 150 is interposed between the trim motor 138 and the propulsion unit 102 and particularly lift belt 142 to protect the components used for trimming the propulsion unit 102 due to any external impact forces 132 that have a component along the trim axis 118 above a predetermined amount.

The trim clutch 150 has engaged configuration in which the output of the trim motor 138 is transferred to the propulsion unit to adjust the position of the propulsion unit 102 relative to base 104 along trim axis 118 and a disengaged configuration in which the propulsion unit 102 is moveable relative to the base 104 without back driving the trim motor 138 through rotational back driving torque at the first trim gear 144.

As will be explained, the components of the trim clutch 150 are configured such that the trim clutch will transition from the engaged configuration (e.g. the normal operating configuration of the trolling motor) to the disengaged configuration when the external impact force 132 has a component parallel to the trim axis equal to or greater than the predetermined amount.

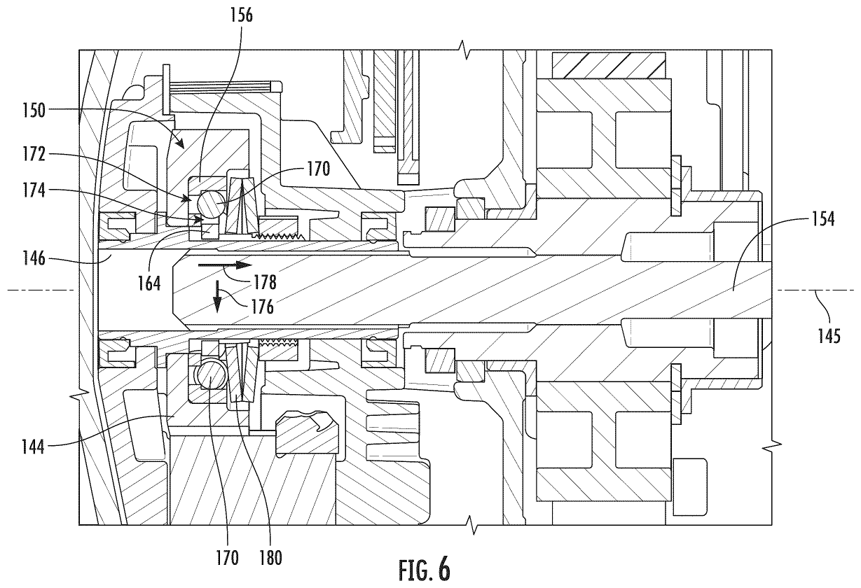

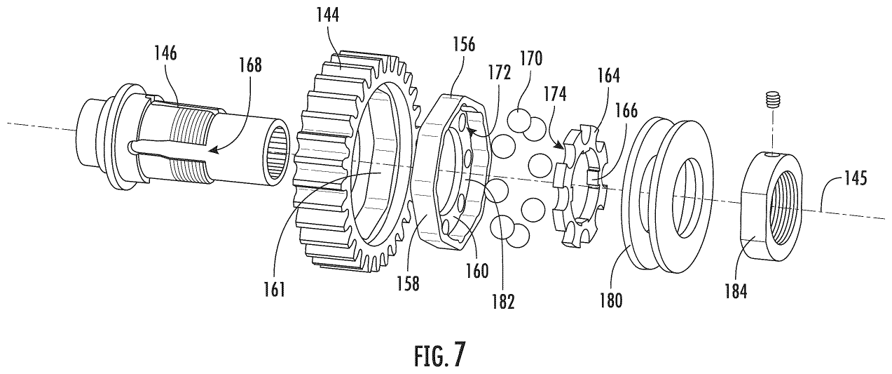

With reference to FIGS. 6 and 7, the trim clutch 150 includes a first carrier 156 rotationally fixed to the first trim gear 144, such that rotation of the first trim gear 144 rotates the first carrier 156 about the trim axis 145. In this example, the first carrier 156 is in the form of a drive ball carrier.

The first carrier 156 has an annular sidewall 158 that extends from a bottom wall 160 such that the first carrier 156 is generally cup shaped in this example. The outer periphery is non-circular and mates with a similarly non-circular shaped inner periphery 161 of a portion of the first trim gear 144. When assembled, the first carrier 156 is inserted axially along axis 145 into the cavity formed by inner periphery 161 and the mating shapes prevent angular rotation of the first carrier 156 relative to the first trim gear 144 about axis 145. As such, rotation of the first trim gear 144 by motor 138 similarly rotates first carrier 156.

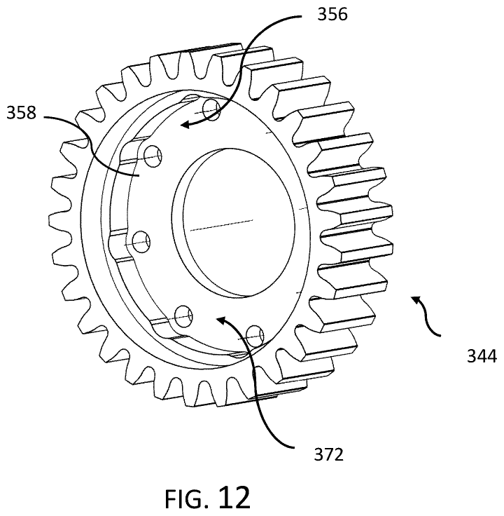

Other means to angularly fix the first carrier 156 or its features into the first trim gear 144 are contemplated. For example, a sufficient friction fit, screws, bolts, pins, adhesives, welding, directly forming the first carrier into the first trim gear 144, etc. are contemplated options. For example, FIG. 12 illustrates a first trim gear 344 that has the first carrier 356 formed directly therein as a one-piece component with pockets 372 formed directly into the first trim gear 344.

Thus, the first carrier 156 may be viewed as being on the trim motor side of the trim clutch 150.

The trim clutch 150 includes a second carrier 164 rotationally fixed to the drive hub 146, such that the drive hub 146 and second carrier 164 rotate together about axis 145. The second carrier 164 may be viewed as being on the propulsion unit side of the trim clutch 150. In this example, the second carrier 164 is in the form of a drive spider.

The second carrier 164 includes radially inward extending tabs 166 that angularly engage within slots 168 of the drive hub 146 to angularly fix the second carrier 164 to the drive hub 146. This engagement prevents the second carrier 164 from rotating relative to the drive hub 146. Other means to rotationally fix the second carrier 164 to the drive hub 146 are contemplated such as adhesives, friction fit, screws, bolts, pins, welding, directly forming the second carrier 164 with the drive hub 146 are contemplated.

In this example, the tabs 166 are slid axially into slots 168 to assembly the two components to one another.

A plurality of clutch engagement members 170 in the form of clutch balls cooperate with angularly spaced apart first pockets 172 in the form of drive ball detents of the first carrier 156 and angularly spaced apart second pockets 174 in the form of drive ball carrier recesses 176 of the second carrier 164.

In particular, when the trim clutch 150 is in the engaged configuration, at least one of the clutch engagement members 170 is inserted into and secured within a corresponding one of the first pockets 172 and is inserted into and secured within a corresponding one of the second pockets 174. This configuration prevents the first carrier 156 from angularly moving relative to the second carrier 164. In particular, rotation torques are able to be transferred between the first trim gear 144/first carrier 156 and the drive hub 146/second carrier 164. Thus, in this configuration, when trim motor 138 is activated, the output thereof is transferred through trim clutch 150 to the drive hub 146 and ultimately to drive the propulsion unit 102 along axis 118.

However, to prevent damage to the system due to back driving forces due to external loading on the propulsion unit 102, the clutch 150 has the disengaged configuration. To transition the trim clutch 150 to the disengaged configuration, the clutch engagement members 170 must move out of engagement with one or both of the first and/or second pockets 172, 174 such that the first and second carriers 156, 164 are permitted to angularly rotate relative to one another about axis 145.

In this example, the shape and configuration of the clutch engagement members 170 along with the shape and configuration of the first pockets 172 is such that the clutch engagement members 170 are biased out of the first pockets 172 when torque is applied thereto. With particular reference to FIG. 6, when torque is applied, the torque will bias the clutch balls 170 radially inward as illustrated by arrow 176 as well as axially parallel to axis 145 as illustrated by arrow 178. This will push the clutch balls 170 out of engagement with the first pocket 172 such that the clutch balls 170 and second carrier 164 can move relative to the first carrier 172 angularly about axis 145.

To maintain the engagement members 170 in the first pockets 172 during normal operation, e.g. when torques below a predetermined threshold are applied, such as when trimming the propulsion unit 102 along trim axis 118, biasing member 180 acts to bias the engagement members 170 into the first pockets 172 in a direction opposite arrows 176, 178. However, when the torque applied to the clutch balls 170 is too great, the force applied thereto will overcome the biasing force provided by biasing member 180 and the clutch ball 170 will not remain with the first pocket 172 and the trim clutch 150 will have transitioned from the engaged configuration to the disengaged configuration. In this example, the clutch balls 170 will be pushed out of first pockets 172 resiliently compressing the biasing member 180 (e.g. clutch spring).

The second pockets 172 are sized and configured to allow the axial movement of the clutch balls as represented by arrow 178 as well as the radial movement as represented by arrow 176.

In this example, the clutch balls 170 remain in engagement with the second pocket 172 at all times. As such, the clutch balls 170 and second carrier 164 move angularly about axis 145 in unison. This is because the clutch balls 170 need only disengage from one of the two carriers 156, 164 to permit angular movement therebetween.

In this example, the second carrier 164 translates back driving force, such as by an external impact force 132, to the clutch balls 170. If the load on the second carrier 164 is greater than the load of the biasing member 180 (e.g. the spring) pressing against the clutch balls 170, the clutch balls 170 will roll out of the first pockets 172 (e.g. inward radially and parallel to axis 145) until they are out of the first pockets 172. If the axial displacement of the propulsion unit 102 along trim axis 118 is sufficient enough, the clutch balls 17o will roll on the inner face 182 of end wall 160.

In this example, there is no limit on the amount of angular displacement between the first and second carriers 156, 164. The angular displacement is dependent on the amount of axial displacement of the propulsion unit 102 along axis 145 before the impact loading is reduced to below the predetermined amount. For example, this could occur with the clutch ball 170 transitioning to the immediate adjacent first pocket 172 or could result in the clutch ball 170 making numerous complete rotations about the axis 145. Thus, the clutch ball 170 could stop in the same first pocket 172 or a different first pocket 172 upon the final reduction of the torque below the predetermined amount.

By allowing the clutch balls 170 roll out of the first pockets 172, the back driving force does not exceed the predetermined values preventing permanent damage to the trim system.

An adjustment collar 184 is threadedly attached to the drive hub 146. The adjustment collar 184 biases the spring member 180 into the clutch balls 170 to keep the clutch assembled. Also, the collar 184 can adjust the preload of the biasing member 180 on the clutch balls 170 adjusting the positioning of the collar 184 along the drive hub 146.

The axial external loading 132 applied to the propulsion unit 102 is converted to torque about clutch axis 145 by way of the lift belt 142 acting on trim pully 152. This torque is transmitted to the drive hub 146 via trim shaft 154. The torque is then transmitted from drive hub 146 to the drive spider 164. When this torque is above a predetermined amount, the drive spider 164 angular loading of the clutch balls 170 about axis 145 drives the clutch balls 170 out of engagement with first pockets 172 to allow for slippage in the trim clutch 150 rather than damage to the components of the trim system. In particular, the first and second carriers 156, 164 are allowed to rotate angularly about axis 145 relative to one another.

Once the propulsion unit 102 has traveled a sufficient distance along the trim axis 118 and the external load has dropped below the predetermined amount, the torque on the clutch balls 170 similar drops and they clutch balls 170 will remain within the first pockets 172 of the first carrier 156.

With the clutch balls 170 traversing the interface between the first carrier and second carrier 156, 164 the two components are once again rotationally fixed to one another such that operation of the trim motor will operably drive the propulsion unit 102 (via the intervening gear train) along the trim axis 118.

However, in this situation, the components of the trim system are not damaged due to the protections provided by the slippage presented by the trim clutch 150.

The trolling motor 100 may include various sensors such as sensors that monitor the trim position as well as the steering position. Other sensors in the system may include deployment latch sensor, ramp parked sensor, and a tilt knuckle stowed sensor. These sensors all provide feedback as to the operational state of the trolling motor such as the direction the propulsion unit 102 is aimed (e.g. steering position), the depth of the propulsion unit 102 (e.g. trim position), whether or not the trolling motor is stowed or deployed, whether the trolling motor 100 is latched in the stowed orientation, etc.

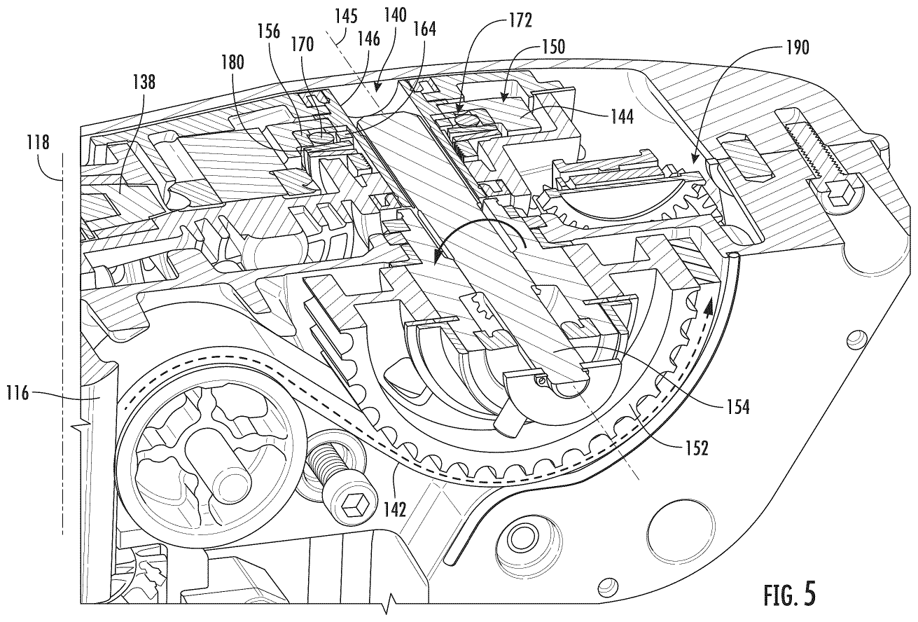

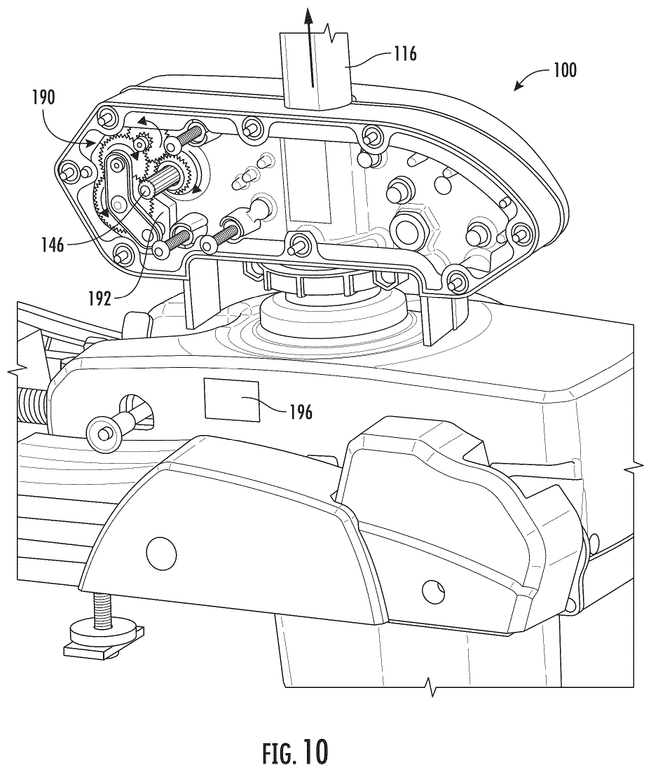

With reference to FIGS. 5 and 10, the trim shaft 146 operably (directly or indirectly) drives a trim position gear train 190 such that the position of the propulsion unit 102 can be sensed. The trim shaft 146 is generally on the propulsion unit side of the trim clutch 150 such that even upon an unexpected trim event, e.g. due to impact forces 132, the trim position gear train 190 will rotate even when the trim clutch 150 transitions to the disengaged configuration.

A sensor 192 cooperates with a magnet embedded in sensor gear 194 of the trim position gear train 190 to track and monitor the trim position of the propulsion unit 102. In particular, when the propulsion system 102 moves along the trim axis 118 sensor gear 194 is rotated a corresponding amount and the sensor 192 can track the amount and direction of the travel.

Preferably, this sensor 192 can monitor travel due to operation of the trim motor 138 as well as due to slippage resulting from excessive impact forces 132 that cause clutch 150 to disengage.

This sensed position information may be fed to a controller 196. The controller 196 can include an appropriate processor and/or storage to determine changes in the trim position. The control 196 can also determine or is fed information related to when a user initiates a user initiated trim event. If no such user initiated trim event occurs, but a trim event is sensed due to a sensed change in trim position, the controller 196 can determine that an unexpected trim event has occurred.

Upon detecting an unexpected trim event, the controller 196 can generate an error signal. Such an error signal could be used to induce an audible alarm, a notification such as a text flag on a remote or other display associated with the trolling motor 100. For example, a notification could be displayed on an app on a phone or on a screen of a fish finder. Further yet, a visual notification, such as light or blinking light, on the trolling motor 100 itself could be initiated from the error signal.

In simpler systems, this alarm/notification may be all that is generated by the trolling motor.

In other systems, the user may be queried to determine if it was in fact an unexpected or even detrimental trim event or something not unexpected. For instance, the system could flag the user for interaction and query the user to indicate whether or not there was an unexpected trim event.

Because some trolling motors have basic storage diagnostics such as time on, trim events, steering events, etc., if the user indicates there was an unexpected trim event, the unexpected trim event information including date, time, total change in trim position, the actual trim position before and/or after the event, etc. could then be stored in the controller 196. This information could be used to assess potential damage to the trolling motor 100 (and its trim position system) as well as then used to assess whether or not a warranty claim can be approved.

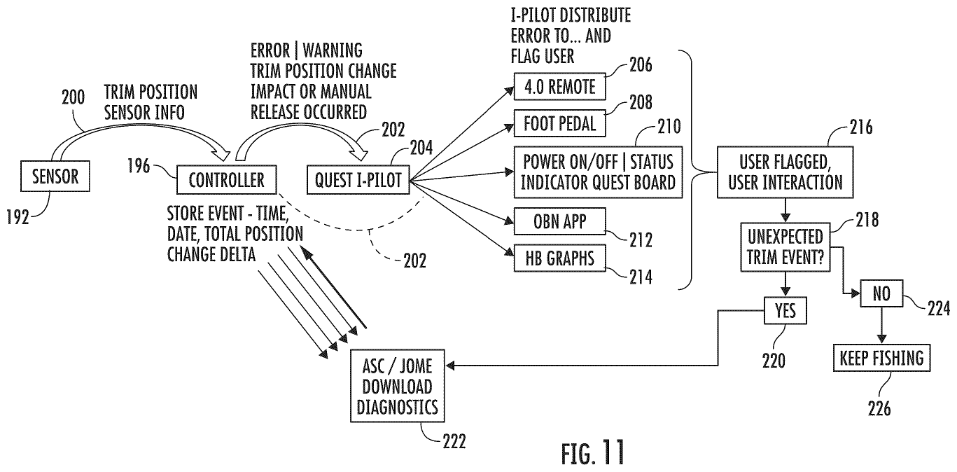

FIG. 11 is a flow chart that schematically illustrates the sensor system. In particular, sensor 192 transmits the trim position information 200 to controller 196. If the controller 196 senses an unexpected trim event, an error signal 202 may be sent to other components. In FIG. 11, the information is sent to an I-Pilot trolling motor control system 204. The I-Pilot trolling motor control system 204 can then distribute the error signal to other user interface components of the system such as a remote control 206 for the trolling motor 100, a foot pedal 208 for controlling the trolling motor 100 (e.g. to a warning light or an audible alarm 210), to an app 212 on a cell phone or other handheld device that communicates with the system (such as the MinnKota One Boat Network App “OBN App”), to fish finder displays 214, wearable devices, etc.

In other embodiments, the I-pilot component 204 may be skipped and the controller 196 could communicate the error signal directly to any one or multiple ones of the user interface components outlined previously.

In the more complex system, the user interface component may flag the user for input, such as at blocks 216 and 218 to determine if there was an unexpected trim event. If the user inputs yes at block 220, the information may be recorded, such as at block 222. Further yet, that information could be sent back to the trolling motor controller 196 to perform diagnostics on the overall trim system and/or to initiate a recalibration of the system. If the user says no, such as at block 224, then no further action may occur such as at block 226.

The trim position sensor 190 may be hardwired to controller 196 or may communicate wirelessly. Similarly, controller 196 may be hard wire connected to any of the user interface components and/or the I-Pilot system.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A trolling motor comprising:
a base configured to be attached to a boat;
a propulsion unit configured to generate thrust along a thrust axis of the propulsion unit when in use within a body of water, the propulsion unit being moveable relative to the base along a trim axis to adjust a trim position of the propulsion unit relative to a surface of the body of water when in use;
a trim motor operably attached to the propulsion unit configured to drive the propulsion unit along the trim axis to adjust the trim position of the propulsion unit; and
a trim clutch interposed between the trim motor and the propulsion unit, the trim clutch having an engaged configuration in which operation of the trim motor drives the propulsion unit along the trim axis and a disengaged configuration in which the propulsion unit is moveable relative to the base along the trim axis without back driving the trim motor, the trim clutch configured to transition from the engaged configuration to the disengaged configuration when at least a predetermined external load parallel to the trim axis is applied to the propulsion unit.

2. The trolling motor of claim 1, further comprising:
a steering motor operably attached to the propulsion unit to rotate the propulsion unit about the trim axis to adjust an angular orientation of the thrust axis relative to the base.

3. The trolling motor of claim 1, wherein:
the trim clutch is part of a drive train interposed between the trim motor and the propulsion unit;
the drive train includes:
a first trim gear operably coupled to the propulsion unit, the first trim gear rotating about a trim clutch axis;
a second trim gear operably driven by the trim motor for rotation about the trim clutch axis, the trim clutch interposed between the first and second trim gears, the trim clutch operably rotationally coupling the first trim gear to the second trim gear when in the engaged configuration and rotationally decoupling the first trim gear from the second trim gear when in the disengaged configuration.

4. The trolling motor of claim 3, wherein:
the trim clutch includes:
a first carrier rotationally fixed to one of the first or second first trim gears, the first carrier having a first pocket;
a second carrier rotationally fixed to the other one of the first or second trim gear, the second carrier having a second pocket;
a clutch engagement member, the clutch engagement member being located in the first and second pockets rotationally fixing the first carrier to the second carrier when the trim clutch is in the engaged configuration, the clutch engagement member being removed from the first pocket when the trim clutch is in the disengaged configuration such that the first carrier is not rotationally fixed to the second carrier.

5. The trolling motor of claim 4, wherein the first pocket, second pocket and clutch engagement member are configured to transition the clutch engagement member out of the first pocket due to application of the predetermined external load parallel to the trim axis to the propulsion unit.

6. The trolling motor of claim 5, wherein:
the clutch engagement member is a clutch ball, the clutch ball extends into the first pocket a depth less than a radius of the clutch ball such that any force applied between the first carrier and the clutch ball is offset from the great circle of the clutch ball;
a biasing member acts to bias the clutch ball into the first pocket to maintain the clutch in the engaged configuration until the predetermined external force is applied to the propulsion unit.

7. The trolling motor of claim 6, wherein:
the second pocket of the second carrier engages the clutch ball at a great circle of the clutch ball; and
the clutch ball is axially slidable parallel to the clutch trim clutch axis within the second pocket when transitioning between the engaged and disengaged configurations while the second carrier remains engaged with the great circle of the clutch ball.

8. The trolling motor of claim 6, wherein when the predetermined external force is applied to the propulsion unit, the clutch ball moves axially parallel to the trim clutch axis and angularly about the trim clutch axis to allow the first carrier to move angularly relative to the second carrier.

9. The trolling motor of claim 1, wherein:
the trim clutch includes:
a drive ball retainer having a plurality of drive ball detents angularly spaced about a trim clutch axis;
a drive spider having a drive ball carrier recess, the drive spider angularly moveable relative to the drive ball retainer when the trim clutch is in the disengaged configuration;
at least one clutch engagement member in the form of a clutch ball receivable in the drive ball detents;
when in the engaged configuration, the clutch ball rotationally fixes the drive ball retainer to the drive spider when the clutch ball is located within a first one of the drive ball detents and the drive ball carrier recess;
when in the disengaged configuration, the clutch ball may move about the clutch axis angularly from a first one of the drive ball detents to an angularly adjacent second one of the drive ball detents allowing angular movement of the drive ball retainer relative to the drive spider without rotationally back driving the trim motor.

10. The trolling motor of claim 9, wherein the clutch ball remains in the drive ball carrier recess of the drive spider as the clutch ball transitions from the first one of the drive ball detents to the second one of the drive ball detents.

11. The trolling motor of claim 9, wherein:
the drive ball detents are configured to require the clutch ball to move radially relative to the trim clutch axis and parallel to the trim clutch axis to disengage and remove the clutch ball from the drive ball detent to transition the trim clutch from the engaged configuration to the disengaged configuration; and
the drive ball carrier recess of the drive spider is configured to allow the clutch ball to move parallel to the trim clutch axis and radially relative to the trim clutch axis while remaining within the drive ball carrier recess as the trim clutch transitions from the engaged configuration to the disengaged configuration.

12. The trolling motor of claim 9, wherein a biasing member biases the clutch ball toward engagement with an angularly aligned one of the plurality of drive ball detents until the predetermined external load is applied to the propulsion unit such that sufficient torque is generated between the drive ball carrier and the drive spider to drive the clutch ball out of the angularly aligned one of the plurality of drive ball detents.

13. The trolling motor of claim 9, wherein the drive spider has a plurality of angularly spaced apart drive ball recesses and the at least one clutch engagement member includes a plurality of drive balls, each drive ball recess having a drive ball therein.

14. The trolling motor of claim 9, wherein there is no limit to the amount of angular displacement about the clutch trim axis that the drive ball retainer may travel relative to the drive spider.

15. The trolling motor of claim 11, wherein the drive ball retainer includes an annular sidewall extending axially parallel to the clutch axis from a first face of an end wall, each drive ball carrier recess having a portion formed in a radially inner surface of the annular sidewall and a portion formed in the first face of the end wall.

16. The trolling motor of claim 15, wherein the clutch ball travels along the first face of the end wall as the clutch ball transitions between adjacent drive ball retainer recesses when the drive spider moves angularly relative to the drive ball retainer when the trim clutch is in the disengaged configuration.

17. The trolling motor of claim 1, wherein the trim axis is generally orthogonal to the thrust axis.

18. The trolling motor of claim 1, wherein the base and propulsion unit have a deployed configuration in which the trim axis is generally vertical.

19. The trolling motor of claim 3, wherein the trim clutch axis is perpendicular to the trim axis when the trim motor drives the propulsion unit along the trim axis.

20. The trolling motor of claim 1, wherein:
the trim clutch includes:
a first carrier rotationally coupled to and driven by the trim motor, the first carrier having a first pocket;
a second carrier rotationally coupled to the propulsion unit to drive the propulsion unit along the trim axis, the second carrier having a second pocket;
a clutch engagement member, the clutch engagement member being located in the first and second pockets rotationally fixing the first carrier to the second carrier when the trim clutch is in the engaged configuration, the clutch engagement member being removed from at least one of the first or second pockets when the trim clutch is in the disengaged configuration such that the first carrier is not rotationally fixed to the second carrier and the trim motor is decoupled from the propulsion unit.

21. The trolling motor of claim 20, wherein:
the clutch engagement member is a drive ball, one of the first and second carriers is a drive ball retainer, and one of the first and second carriers is a drive spider;
the drive ball being removed from the pocket of the drive ball retainer in the disengaged configuration.

22. The trolling motor of claim 21, wherein the drive ball, drive ball retainer, and drive spider are configured such that torque generated by the predetermined external force causes the drive ball to be driven out of the first pocket but that the drive ball remains within the second pocket as the drive ball retainer rotates relative to the drive spider about the trim clutch axis.

23. The trolling motor of claim 20, wherein:
the trim clutch includes:
a first carrier rotationally coupled to and driven by the trim motor, the first carrier having a first pocket;
a second carrier rotationally coupled to the propulsion unit to drive the propulsion unit along the trim axis, the second carrier having a second pocket;
a clutch engagement member, the clutch engagement member being located in the first and second pockets rotationally fixing the first carrier to the second carrier when the trim clutch is in the engaged configuration, the clutch engagement member being removed from at least one of the first or second pockets when the trim clutch is in the disengaged configuration such that the first carrier is not rotationally fixed to the second carrier and the trim motor is decoupled from the propulsion unit.

24. The trolling motor of claim 1, further comprising:
a trim sensor assembly having a controller configured to receive trim position information from a propulsion unit trim sensor, the propulsion unit trim sensor sensing the position of the propulsion unit along the trim axis, the controller configured to determine that an unexpected trim event has occurred when a change in the position of the propulsion unit is sensed by the propulsion unit trim sensor without a corresponding trim input.

25. The trolling motor of claim 24, wherein the sensor assembly includes storage for storing when an unexpected trim event occurs.

26. The trolling motor of claim 24, wherein the sensor assembly is configured to store, in storage, the amount of change in trim associated with a sensed unexpected trim event.

27. The trolling motor of claim 24, wherein the controller is configured to induce an error signal upon determining that an unexpected trim event has occurred.

28. The trolling motor of claim 27, wherein the error signal may be used for or include an audible alarm, a visual alarm, a notification on a remote for controlling the trolling motor, generating a notification on a fish finder, or a notification on a phone.

29. The trolling motor of claim 24, wherein the trim sensor is configured to generate an unexpected trim event error signal to the user to query the user if there was an unexpected trim event, the trim sensor assembly is configured to receive an input from the user to determine whether the unexpected trim event was undesired.

30. The trolling motor of claim 24, wherein the sensor assembly is configured to output an error signal upon sensing an unexpected trim event.
